(19) United States
(12) Patent Application Publication
(10) Pub. No.: US 2013/0118445 A1
(43) Pub. Date: May 16, 2013

(54) ROTARY PISTON ENGINE

(71) Applicant: Lonny J. Doyle, Red Oak, TX (US)

(72) Inventor: Lonny J. Doyle, Red Oak, TX (US)

(21) Appl. No.: 13/700,118

(22) PCT Filed: Jun. 4, 2010
(86) PCT No.: PCT/US2010/001629

§ 371 Date: Jan. 31, 2013

(51) Int. Cl. F02B 53/04

(52) U.S. Cl. CPC F02B 53/04
USPC 123/200

(57) ABSTRACT

The rotary piston engine 10 has a stationary central core 12 having a primary axis and radially offset inlet and combustion sections, the cylinder rows and their pistons rotating about the offset inlet and combustion sections, and the outer housing 18 rotating concentrically about the primary axis of the core 12. The cylinder rows are linked to the outer housing 18 to provide a 1:1 rotational correspondence, despite the different rotational axes of the cylinder rows and outer housing 18. The pistons are connected to the concentrically rotating outer housing 18 by connecting rods, thus moving inwardly and outwardly in their cylinders as their cylinder rows rotate about the radially offset inlet and combustion sections of the core 12. The engine 10 is devoid of complex valve mechanisms due to the rotary valve effect provided by the rotation of the cylinder rows around the stationary core 12.

### TECHNICAL FIELD

The present invention relates generally to internal combustion engines, and more particularly to a rotary piston engine having multiple rows of radially disposed cylinders therein, each row of cylinders containing multiple pistons having their crowns oriented inwardly toward a single stationary core containing the intake and combustion chambers. The cylinder rows and outer housing rotate around the stationary core.

### BACKGROUND ART

The development of the internal combustion engine as a prime mover has been known to for well over a century at the time of this writing, with innumerable different variations having been developed over the years. By far the most common engine configuration is the four-stroke cycle (or Otto cycle) reciprocating engine, wherein one or more cylinders in various configurations and arrangements contain pistons that are driven by the force of expanding burning gases in their combustion chambers. The pistons are linked to a crankshaft that delivers the power output from the engine. Generally, the intake charges and exhaust gases are routed to and from the combustion chambers by a number of valves in each cylinder head, with the valves in turn being actuated by other mechanical linkages from the rotation of the crankshaft. The result is a relatively complex mechanical system that is accepted as the standard prime mover likely only because of extended development and refinement over decades of use.

Various other alternative engine configurations have been developed in the past as well. One such configuration is known as the rotary engine. This term was originally applied to engines used in early aircraft, wherein the crankshaft was a stationary component secured to the aircraft structure and the propeller was secured to the engine case, which spun around the stationary crankshaft during engine operation. Such a system has its advantages in terms of air cooling the radially extending cylinders during operation. However, the need to deliver intake charges and remove exhaust gases from each of the rotating cylinders with their separate outwardly disposed cylinder heads, as well as to provide accurately timed ignition pulses to each rotating cylinder, resulted in a relatively complex system for the time with numerous operating limitations, e.g., extremely limited control of engine speed, for one.

More recently the term “rotary engine” has been applied to an engine having a stationary outer case with an epitrochoidal chamber therein, with a three-lobed rotor rotating eccentrically within the chamber and driving a rotating shaft. This configuration is known as the Wankel engine, and may be constructed to have one or more rows of chambers and rotors within the stationary case. Such an engine configuration has numerous advantages in terms of simplicity due to the elimination of the complex valve train and connecting rod system, but this engine configuration has not been seen to provide the fuel efficiency of the more conventional reciprocating piston engine. Moreover, exhaust emissions are becoming an ever-greater concern, and the Wankel engine has proven to be more difficult to develop in terms of minimizing exhaust emissions. The Wankel engine is not a true rotary engine, as the outer case is stationary while the rotor and central shaft rotate therein. The term “rotary” was applied to the Wankel configuration due to the multi-lobed rotor rotating eccentrically within the case.

Thus, a rotary piston engine solving the aforementioned problems is desired.

### DISCLOSURE OF INVENTION

The rotary piston engine is a true rotary engine, having multiple cylinder rows and an outer housing revolving around a stationary central core during operation. The core includes a separate intake and combustion section and chamber for each cylinder row, the intake and combustion sections being radially offset from the primary axis of the core and the axis of rotation of the outer housing, which is concentric with the primary axis of the core. The cylinder rows rotate directly about the radially offset intake and combustion sections of the core during operation, i.e., about an axis or axes that are offset from the axis of the core and outer housing. A series of links connect the cylinder rows to the outer housing to assure that the cylinder rows and outer housing rotate in a 1:1 correspondence with one another, despite their different axes of rotation. While multiple cylinder rows are included in the engine, these rows may comprise individual cylinder cases rigidly secured to one another (e.g., bolted, etc.), or may comprise a single case having multiple cylinder rows therein.

Each cylinder row contains a plurality of cylinders and pistons disposed in a radial array. The crowns of the pistons are oriented inwardly toward the central core, the piston skirts being oriented outwardly toward the outer housing. The pistons are connected to the outer housing by connecting rods. Thus, the cylinder rows, their pistons and connecting rods, and the outer housing all rotate together during operation. As the cylinder rows rotate about a different axis or axes relative to the outer housing and the pistons are connected directly to the outer housing, it will be seen that the pistons will move inwardly and outwardly in their cylinder bores in the cylinder rows as they rotate about the radially offset inlet and combustion sections of the central core during engine operation. This inward and outward movement of the pistons provides the gas transfer process (intake, compression, power, and exhaust) required for operation of the engine.

The rotary piston engine may contain an even number of cylinder rows and corresponding operating elements of the central core, i.e., two, four, six, eight, etc. This is because the engine operates using a “split cycle” principle, i.e., the intake and compression portions of the cycle are handled by one cylinder row, while the power and exhaust portions of the cycle are handled by an adjacent row of cylinders. While the present disclosure is directed primarily to a two row engine for clarity, it will be seen that engines having four, six, eight, or any other practicable even number of rows may be constructed in accordance with the principles of operation described herein. There is no theoretical restriction upon the number of cylinders and pistons in each row. Alternatively, the rotary piston engine may comprise any practicable number of intake and compression cylinder rows (e.g., two or three rows, etc.) supplying intake charges to one or more power and exhaust rows (e.g., one or two, etc.), depending upon compression ratio(s) of the intake and compression cylinders, relative displacements between rows, and other factors. As the intake and compression cylinder rows serve essentially as an air pump for the central combustion chamber, it will be seen that there is no requirement for volumetric equality between the intake and compression cylinder row(s) and the power and exhaust cylinder row(s).

Intake air enters the intake chamber of the engine core through one end of the stationary core and is delivered to the intake/compression row of cylinders as that row rotates to draw the pistons away from the core. As the pistons travel away from the core, the intake/compression cylinder row rotates to align the intake passage of the core with the cylinders of the outwardly moving pistons, the intake charge flowing from the intake chamber of the central core outwardly into the expanding cylinder volume of the intake/compression cylinders. As the intake/compression row continues to rotate, the pistons travel inwardly in their cylinder bores to compress the intake charge, the intake/compression row simultaneously rotating to align the cylinders in compression with a transfer passage to the combustion chamber within the combustion section of the central core when the pistons are at or near their most inward travel.

Fuel is injected into the central combustion chamber of the core (if the fuel was not previously delivered to the incoming intake charge), and the fuel/air mixture is ignited by an ignition source (spark plug, glow plug, etc., depending upon the specifics of the engine). The engine may be configured for compression ignition (i.e., Diesel) operation, if sufficient compression ratio is provided by the intake/compression cylinder row and a sufficiently compressed charge is transferred to the combustion chamber, so that ignition occurs simultaneously with the direct injection of fuel into the highly compressed charge within the combustion chamber. In any event, the increased pressure of the heated combusted mixture is transferred to the power/exhaust row of cylinders through an outlet port from the combustion chamber of the core as the pistons of the power/exhaust row align with the outlet port when the pistons are near their most inward travel, i.e., as cylinder volume is at or near its minimum. The pressure of the hot combusted mixture forces the power/exhaust pistons outwardly in their cylinder bores, driving the rotation of the outer housing by means of their connecting rods. As all of the pistons are connected to the outer housing via their connecting rods, the rotation of the outer housing and its links to the cylinder case(s) or rows drives rotation of the intake/compression pistons and cylinder row as well. The spent gases of the power/exhaust cylinders are expelled back into the central core through an exhaust passage that is aligned with the cylinder bores as the pistons are near their most outward travel. The pistons expel the exhaust gases from their cylinders as the cylinder row continues to rotate and align with the exhaust port in the central core, the exhaust gases exiting the engine from the exhaust passage of the central core.

The rotary piston engine uses rotation of the cylinder rows and alignment of the pistons with the passages of the central core for the transfer of gases through the engine. Thus, the need for a complex valve train having cams, lifters, springs, rocker arms, etc., is eliminated. Moreover, there is no need for relatively complex fuel delivery and ignition systems serving multiple cylinders, as there is a single intake chamber and single combustion chamber in the central core. A single fuel injector and a single ignition source may be provided to deliver fuel and to provide ignition of the fuel and air charge for the entire engine. Where relatively few cylinders are provided in each cylinder row, separate pulses of fuel are injected into the intake or combustion chamber (where direct fuel injection is used for fuel delivery) at appropriate times, and separate ignition events are timed in the combustion chamber according to the relative positions of the cylinders and their pistons as they rotate about the central core. However, it will be seen that when larger numbers of cylinders and pistons are provided in each cylinder row, the overlap of the intake strokes of the pistons of the intake/compression row and the power strokes of the power/exhaust row will result in the need for essentially continuous intake, fuel injection, ignition, and combustion, thus providing smoothness of operation more closely resembling a turbine engine than a conventional reciprocating engine.

These and other features of the present invention will become readily apparent upon further review of the following specification and drawings.

### BRIEF DESCRIPTION OF THE DRAWINGS

FIG. 1 is a perspective view of a rotary piston engine according to the present invention, illustrating its general configuration.

FIG. 2 is a section view along lines 2-2 of FIG. 1.

FIG. 3 is a perspective view showing the various gas passages of the central core of the rotary piston engine of FIG. 1 in solid lines, the outline of the surrounding core being shown in broken lines.

FIG. 4 is a section view along lines 4-4 of FIG. 2.

FIG. 5 is a section view along lines 5-5 of FIG. 2.

FIG. 6 is a section view along lines 6-6 of FIG. 2.

FIG. 7 is a perspective view of an alternative embodiment of a rotary piston engine according to the present invention, having four cylinder rows.

Similar reference characters denote corresponding features consistently throughout the attached drawings.

### BEST MODES FOR CARRYING OUT THE INVENTION

The rotary piston engine is an internal combustion engine having multiple rows of cylinders disposed in a radial array, in which the piston crowns are oriented inwardly toward a single combustion chamber for each pair of cylinder rows. The central core of the engine contains gas passages for intake, combustion, and exhaust. The core remains stationary. The cylinder rows, their pistons, and the outer housing (to which the cylinder rows and their pistons are connected) rotate about the stationary central core.

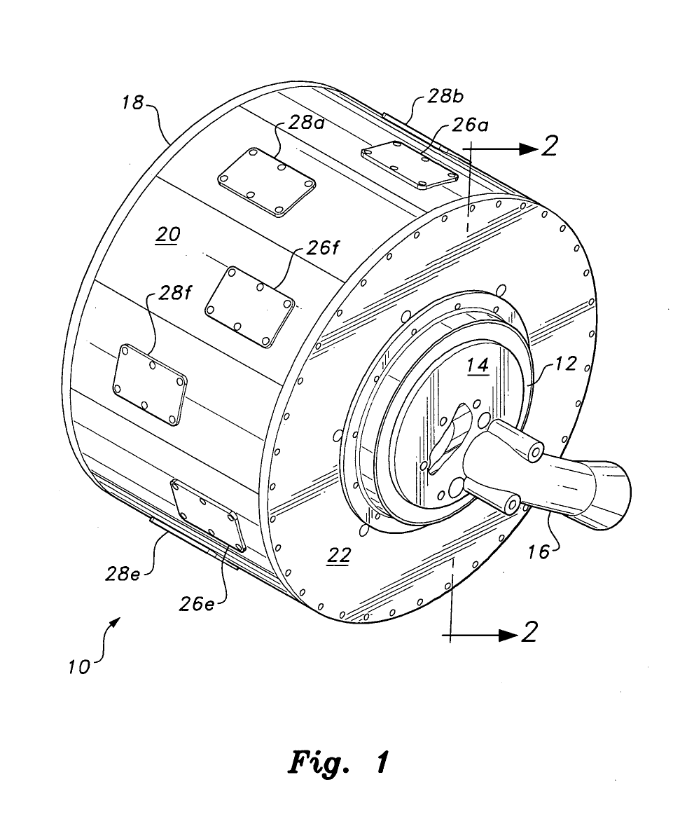

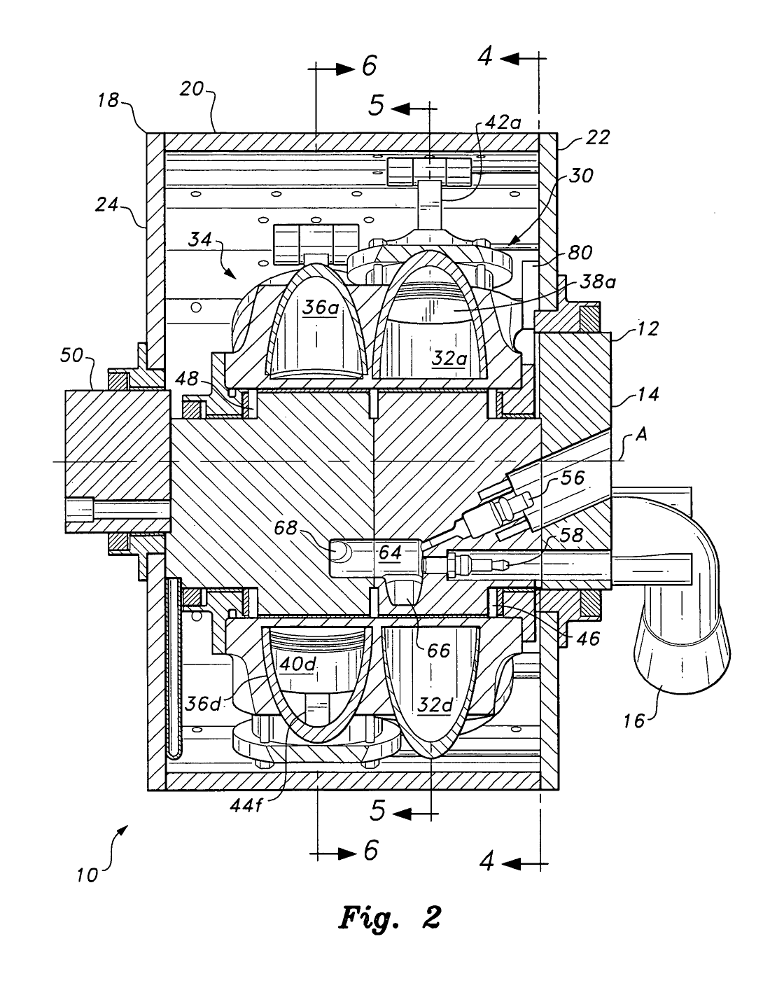

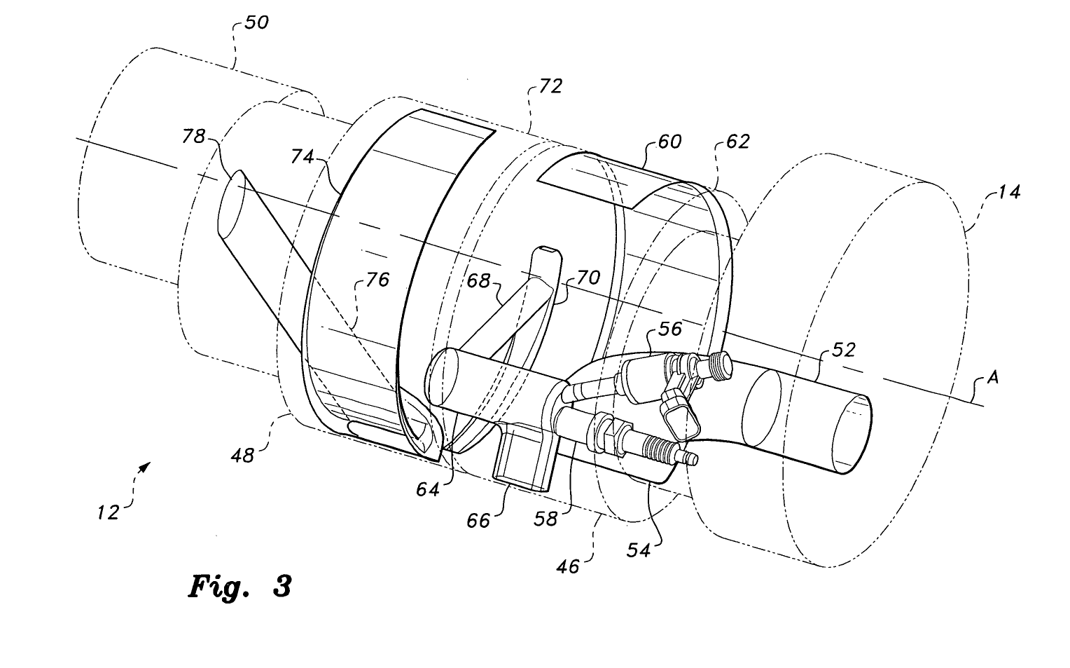

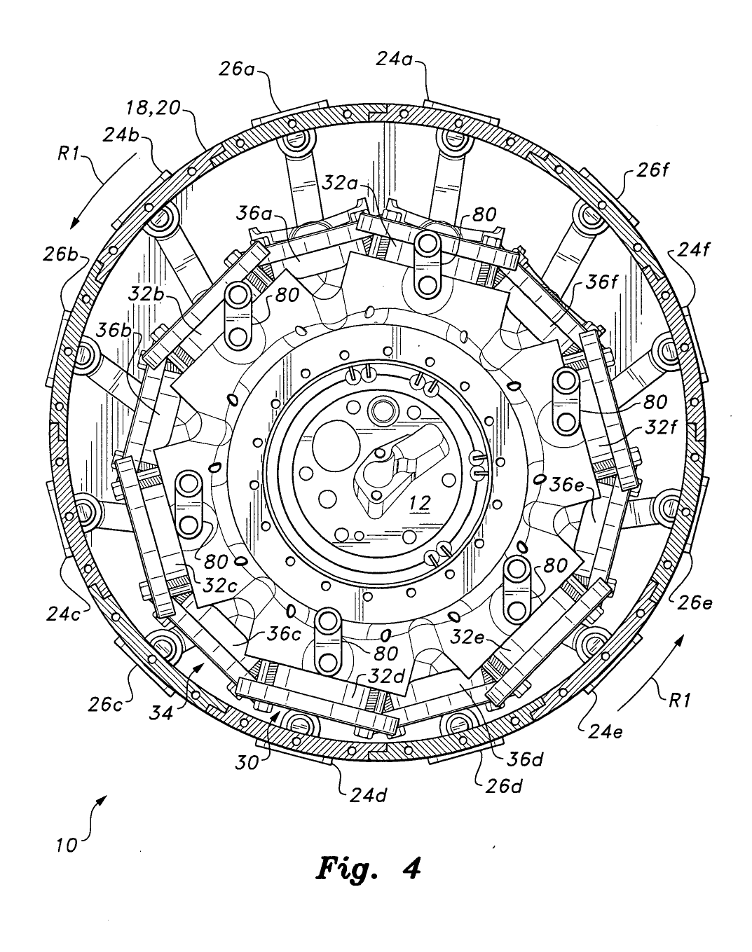

FIG. 1 of the drawings provides a perspective view of an exemplary rotary piston engine 10 having two cylinder rows therein. The view of FIG. 1 is oriented to show the intake end of the engine. The stationary central core 12 (shown completely in FIGS. 2 and 3) has an inlet end 14 having an intake duct 16 extending externally therefrom. The inlet end 14 of the core 12 includes various passages therein for coolant and for access to the ignition component (spark or glow plug, etc.) and fuel injector, if installed. A closed outer housing 18 surrounds and rotates around the stationary central core 12. The housing 18 has a substantially cylindrical outer casing or wall 20, a circular inlet end plate 22, and an opposite outlet end plate 24 (better shown in FIG. 2 of the drawings). The outer casing 20 may be formed as a single, unitary component, or may be formed from a series of arcuate segments. The outer casing 20 includes a plurality of connecting rod attachment plates thereon, designated as intake and compression row plates 26a through 26f and power and exhaust row plates 28a through 28f. All of these plates are shown in FIGS. 4 through 6, and their function is described further below. More or fewer such plates may be required, the number of plates corresponding to the number of cylinders, pistons, and connecting rods of the engine.

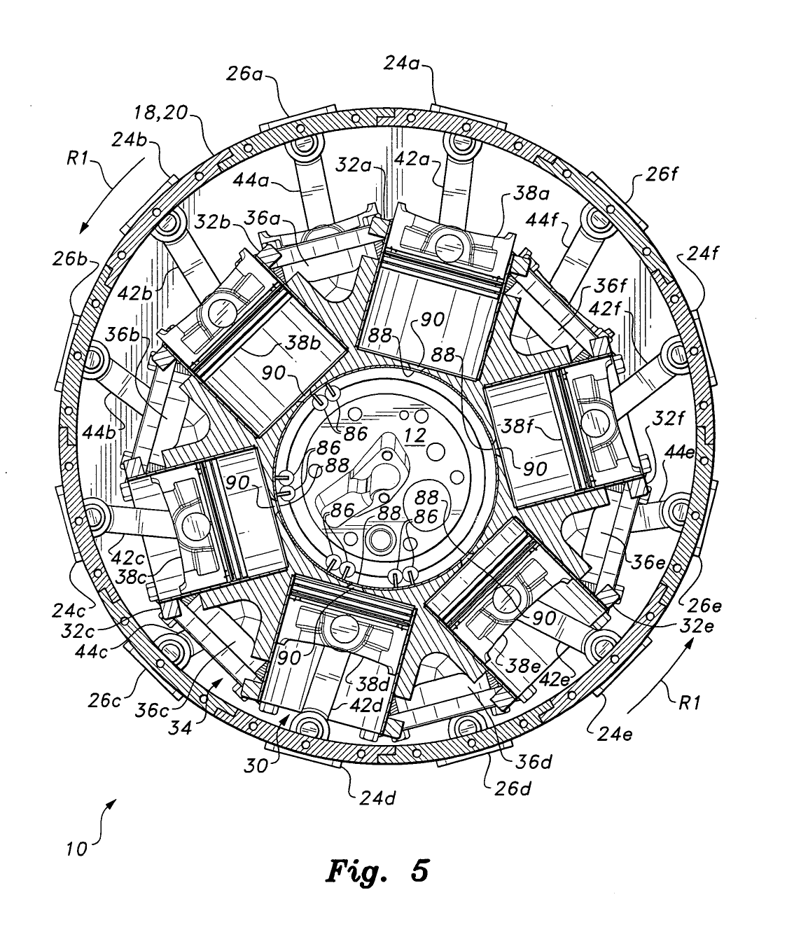

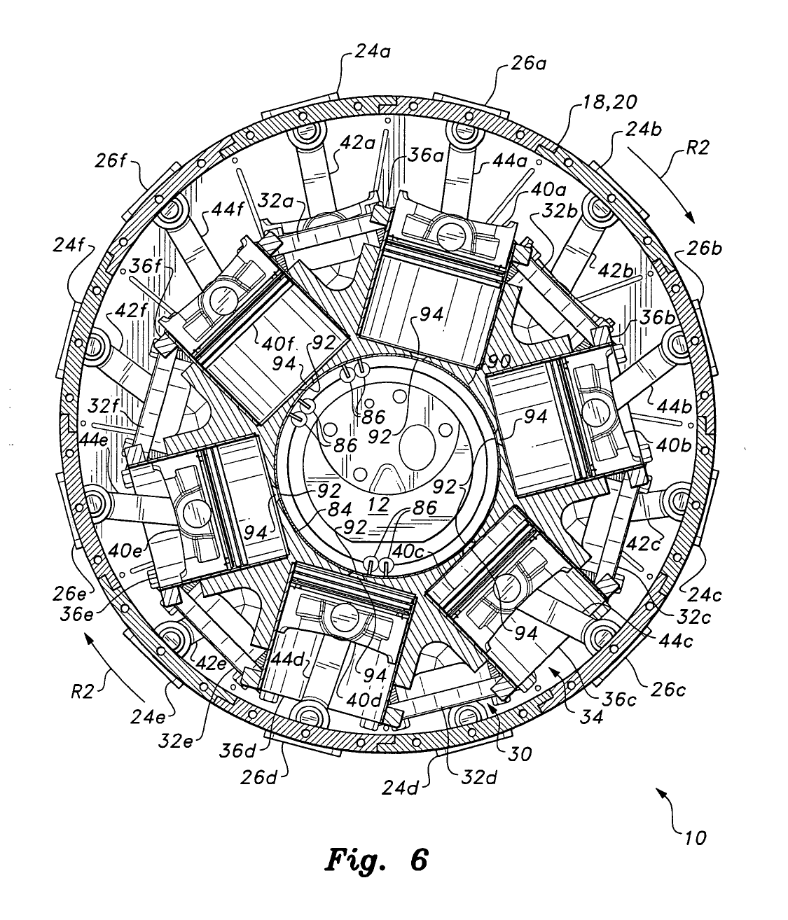

FIG. 2 of the drawings provides a section view of the engine 10 along lines 2-2 of FIG. 1. The interior of the outer housing 18 contains an intake and compression cylinder row 30 with a plurality of intake and compression cylinders 32a through 32f disposed radially therearound, shown more clearly in FIG. 5 of the drawings, and a power and exhaust cylinder row 34 with a plurality of power and exhaust cylinders 36a through 36f disposed radially therearound, shown more clearly in FIG. 6 of the drawings. It will be noted that the progressive orientation of the cylinders and their related components proceeds clockwise in FIG. 6, but is counterclockwise in FIG. 5 due to the opposite directions of the two views. The two cylinder rows 30 and 34 may be constructed as separate cases and joined together (e.g., bolted, etc.) or may be constructed to form a single, unitary cylinder case. The six intake and compression cylinders 32a through 32f and the six power and exhaust cylinders 36a through 36f are shown more completely in FIGS. 5 and 6, respectively.

Each of the cylinders has a rigid, outwardly oriented flange that is spaced apart from its respective cylinder row, each flange having a plurality of bolts extending therethrough and into its cylinder row. Tightening these bolts drives the cylinders into their respective bores in their cylinder cases or rows, compressing the inward edges of the cylinders within the bases of their bores to provide a leakproof seal for each cylinder. It will be understood that the six cylinders of each row is not an absolute requirement. More or fewer cylinders may be provided in each row, if desired. Any practicable even or odd number of cylinders may be provided in the present engine, due to the “split cycle” operation wherein one cylinder row is dedicated only to intake and compression functions and the adjacent cylinder row is dedicated only to power and exhaust functions. This is unlike a conventional radial engine, which is limited to an odd number of cylinders in each row due to the necessity of providing alternating intake and compression strokes in a given cylinder while providing power and exhaust strokes in the adjacent cylinders for smoothness of operation.

It will be further noted in FIGS. 4, 5, and 6 that the two cylinder rows 30 and 34 are staggered relative to one another in an alternating array, i.e., the power and exhaust cylinder row 34 is offset circumferentially about the rotational axis of the engine, relative to the intake and compression cylinder row 30. This circumferential offset comprises an arcuate distance or span about equal to one half of the arcuate span between cylinders. In the twelve cylinder example described herein, each of the six intake and compression cylinders 32a through 32f subtends an angle of sixty degrees therebetween, with the six power and exhaust cylinders to 36a through 36f also having angles of sixty degrees therebetween. However, each alternating intake and compression cylinder is separated arcuately from its adjacent power and exhaust cylinders of the opposite row by an angle of only thirty degrees. This angular staggering of the cylinders in each cylinder row is not an absolute requirement in the present engine 10, as the present engine operates on a “split cycle” principle described briefly above.

Each of the intake and compression cylinders 32a through 32f has an intake and compression piston, respectively 38a through 38f, installed therein, with each of the power and exhaust cylinders 36a through 36f having a power and exhaust piston, respectively 40a through 40f, installed therein. Each of the intake and compression pistons 38a through 38f is connected to its respective intake and compression row connecting rod attachment plate 26a through 26f by an intake and compression connecting rod, respectively 42a through 42f, with each of the power and exhaust pistons 40a through 40f being connected to its respective power and exhaust row connecting rod attachment plate 28a through 28f by a power and exhaust connecting rod 44a through 44f. Thus, the cylinder rows 30 and 34 with their cylinders 32a through 32f and 36a through 36f, their pistons 38a through 40f, and their connecting rods 42a through 44f, rotate in unison with the outer housing 18 about the stationary central core 12, as noted further above. As can be seen clearly in FIGS. 5 and 6 this arrangement orients all of the pistons 38a through 40f with their crowns oriented inwardly, i.e., toward the central core 12, as their skirts are oriented outwardly to provide connection by their wrist pins to their respective connecting rods 42a through 42f to link them to the outer housing 18.

FIG. 3 provides a perspective view of the outline of the stationary central core 12 around which most of the other components of the engine rotate, and a view in solid lines of the gas passages within the core 12 in order to show these passages clearly. The core 12 basically comprises an inlet end 14, an inlet section 46, a combustion section 48, and an outlet end 50, disposed axially in sequence about a central axis A. The inlet end 14 and outlet end 50 are concentric about the central axis A, with the outer housing 18 rotating concentrically about the inlet and outlet ends 14 and 18 of the core 12 and its axis A. The inlet section 46 and combustion section 48 are radially offset from the axis A, with the intake and compression cylinder row 30 and the power and exhaust cylinder row 34 rotating respectively about these offset sections 46 and 48.

The inlet end 14 includes an intake passage 52 therethrough, with the intake passage 52 communicating with the intake duct 16 shown in FIGS. 1 and 2. The intake passage 52 curves or bends radially outwardly to extend to an inlet chamber 54 in the inlet section 46, to somewhat concealed in FIG. 3 by the fuel injector 56 and spark plug or igniter 58. The inlet chamber 54 extends generally outwardly to communicate with a semicircumferential inlet transfer channel 60 formed in the periphery 62 of the inlet section 46 of the core 12. This inlet transfer channel 60 extends about 120 degrees about the periphery 62 of the inlet section 46, and serves to transfer the incoming air charge to the intake and compression cylinders 32a through 32f as they rotate about the inlet section 46 of the stationary core 12. It will be noted that the inlet transfer channel 60 tapers in depth from its maximum depth at the inlet chamber 54 to its opposite distal end, in order to provide a smooth transition from maximum gas flow as the intake and compression pistons 38a through 38f begin their outward travel in their cylinders to closure of gas flow to the intake and compression cylinders 32a through 32f as their pistons 38a through 38f sequentially approach their maximum outward travel during rotation of the cylinder rows. It should be noted that the precise starting and ending points of the inlet transfer channel 60 relative to the intake and compression cylinders 32a through 32f may be adjusted as desired to allow for inertia in the inlet airflow, depending upon factors such as desired rotational speed and torque, etc. The actual operation of the engine 10 is explained in greater detail with particular reference to FIGS. 5 and 6, further below.

A single axially elongate combustion chamber 64 traverses the inlet and combustion sections 46 and 48 of the core 12, with the fuel injector 56 and spark plug or igniter 58 extending into the combustion chamber 64. A compression transfer passage 66 extends from a point on the periphery 62 of the inlet section 46 that corresponds closely with the position of the intake and compression pistons 38a through 38f at their greatest inward travel, i.e., maximum compression of the air charge therein. This compressed charge is sequentially forced into the combustion chamber 64 by the intake and compression pistons 38a through 38f as they rotate about the stationary core and their cylinders 32a through 32f align with the compression transfer passage 66 in sequence. Fuel is injected into the combustion chamber 64 by the single fuel injector 56, whereupon the air and fuel mixture is ignited by the spark plug or igniter 58 to produce the heat and gas pressure required for operation of the engine 10. It will be seen that given a sufficiently high compression ratio in the intake and compression cylinders 32a through 32f, that the engine 10 may be operated as a compression ignition (i.e., Diesel) engine, if so desired.

The very hot, high-pressure combustion gas in the combustion chamber 64 passes through a combustion gas passage 68 to a semicircumferential combustion transfer channel 70 formed in the periphery 72 of the power and exhaust section 48 of the core 12. The combustion transfer channel 70 is shaped much like the inlet transfer channel 60 of the inlet and compression portion 46 of the core 12, i.e., tapering from its greatest depth at a point corresponding to about the most inward travel (minimum cylinder volume) of the power and exhaust pistons 40a through 40f in their cylinders 36a through 36f to its opposite distal end about 120 degrees around the power and exhaust section periphery 72. As in the case of the inlet transfer channel 60, the precise starting and ending points of the combustion transfer channel 70 may be adjusted to allow for inertia in the gas flow, depending upon the operational characteristics desired for the engine 10. The combustion transfer channel 70 is somewhat narrower than the inlet transfer channel 60, as the very high pressure developed within the combustion chamber 64 and passed to the transfer channel 70 does not require a large cross sectional area for gas flow, as does the lower pressure intake flow. The hot, high pressure combustion gas flows along the combustion transfer channel 70 to flow into the power and exhaust cylinders 36a through 36f, forcing their pistons 40a through 40f outwardly in the cylinders to drive their connecting rods 44a through 44f against their attachment plates 28a through 28f of the outer casing 20, with the radially offset rods 44a through 44f forcing the outer casing 20 and housing 18 to rotate about the stationary core 12. The housing 18 is linked to the intake and compression cylinder row 30 and the power and exhaust cylinder row 34 by a series of links, described further below.

A semicircumferential exhaust transfer passage 74 extends about a portion of the periphery 72 of the combustion section 48 of the core 12 and in the same diametric plane as the combustion channel 70. The exhaust transfer passage 74 is oriented to receive exhaust gas from the power and exhaust cylinders 36a through 36f from a point about where the power and exhaust pistons 40a through 40f are at their most outward travel, i.e., where their cylinder volumes are at their greatest. Again, the precise starting and ending points of the exhaust transfer passage 74 may be adjusted as desired for the desired engine operational characteristics. The exhaust transfer passage 74 communicates with an exhaust gas passage 76 that extends from the trailing end of the exhaust transfer passage 74 inwardly into the power and exhaust section 48 of the core 12. The exhaust gas passage 76 communicates with an exhaust passage 78 that extends through the exhaust outlet end 50 of the core 12, to complete the gas flow process of the engine 10.

FIG. 4 illustrates the links 80 that connect the intake and compression cylinder row 30 to the inside of the inlet end plate 22 (not shown in FIG. 4, for clarity), with one of the links 80 also being illustrated in the side elevation view in section of FIG. 2. The axis of rotation of the two cylinder rows 30 and 34 about the radially offset inlet and combustion sections 46 and 48 of the core 12, relative to the axially concentric rotation of the outer housing 18 about the axis A of the core 12, produces the inward and outward travel of the intake and compression pistons 38a through 38f and the power and exhaust pistons 40a through 40f as the cylinder rows 30 and 34 and the outer housing 18 rotate. While the rotating cylinder rows 30 and 34 are connected to the outer housing 18 by their pistons and connecting rods, this does not provide a positive rotational registry for the inner cylinder rows 30 and 34 and the outer housing 18 due to the pivotal attachment of the rods to their pistons and to the connecting rod attachment plates of the outer casing 20. Accordingly, some means must be provided to cause the cylinder rows 30 and 34 to rotate in unison with the outer housing 18, even though the cylinder rows and outer housing rotate about different axes.

The links 80 accomplish this function, with one end of each link being attached to the intake and compression cylinder row 30 and the opposite end of each link being attached to the inside of the inlet end plate 22 of the engine 10. The lengths of the links between their two pivot points are precisely equal to the radial difference between the axis of rotation of the cylinder rows 30 and 34, and the central axis A of the core 12 about which the housing 18 rotates. It will be seen that the links 80 maintain the same longitudinal orientation during engine operation, e.g., essentially vertical as shown in FIG. 4 of the drawings when the intake and compression pistons 38a through 38f are at their maximum outward travel at the top of the engine, per the orientation of FIG. 4. That is, the links 80 travel around the stationary core 12 as the cylinder row 30 and housing 18 rotate, but they maintain their vertical alignment (when the engine 10 is oriented as shown in FIG. 4) throughout their rotation about the core 12. Moreover, it will be seen that more or fewer such links may be provided as desired, and/or such links 80 may be installed between the power and exhaust cylinder row 34 and the outlet end plate 24, if so desired. Such interconnecting links at both ends of the engine may be advantageous in reducing torsional stresses between the cylinder rows and the housing, as well.

FIGS. 5 and 6 of the drawings may be used to demonstrate the operation of the rotary piston engine 10. A hard metal (steel, etc.) intake seal band 82 is pressed into the center of the intake and compression cylinder row 30 (FIG. 5), with a similar power and exhaust seal band 84 being pressed into the center of the power and exhaust cylinder row 34 (FIG. 6). These bands 82 and 84 are immovably affixed within their respective cylinder rows 30 and 34 and rotate therewith during engine operation, and serve primarily as a bearing surface for the seals 86 that are affixed to the stationary central core 12. The intake and compression seal band 82 has a series of intake and compression passages 88 therethrough, with these passages 88 being aligned with corresponding intake and compression cylinder head passages 90 formed through the inner wall of the intake and compression cylinder row 30 and communicating with each of the intake and compression cylinders 32a through 32f. The power and exhaust seal band 84 includes a similar series of power and exhaust passages 92 therethrough, with these passages 92 being aligned with corresponding power and exhaust cylinder head passages 94 in the inner wall of the power and exhaust cylinder row 34.

The intake and compression cycle of FIG. 5 will be discussed initially. This discussion assumes that the rotary components of the engine, i.e., the inlet and compression cylinder row 30, its pistons 38a through 38f, the connecting rods 42a through 42f, and the outer casing 20 of the housing 18, are all rotating counterclockwise about the inlet section 46 of the stationary core 12 as viewed in FIG. 5, as indicated by the rotational arrow R1. In the orientation of the engine 10 illustrated in FIGS. 5 and 6, the radial offset of the intake and combustion sections 46 and 48 of the core 12 are toward the lowermost portion of the drawing Fig., thus resulting in the least distance between those components of the core 12 and the cylindrical outer casing 20. This results in the lower connecting rods, e.g., rod 42d in FIG. 5, pushing its piston 38d as far inwardly within its cylinder 32d as possible, i.e., having the smallest possible cylinder volume. At this point, the rotating cylinder 32d is aligned with the first end of the inlet transfer channel 60 (FIG. 3) of the stationary core 12. As the intake and compression cylinder row 30 continues to rotate, the distance between the cylinder row 30 and the outer casing 20 begins to increase, thus drawing the piston outwardly in its cylinder, as shown by the position of cylinder 32e and piston 38e in FIG. 5. This causes the volume within the cylinder to increase, thereby drawing intake air into the cylinder. This process continues through the rotation of the intake and compression cylinder row 30 about the stationary core 12 for the semicircumferential length of the inlet transfer channel 60, i.e., to about the position of the cylinder 32a and its piston 38a, whereupon intake flow is cut off as the cylinder passes the end of the inlet transfer channel 60.

At this point, the distance between the outer casing 20 and the intake and compression cylinder row 30 begins to decrease, with the pistons moving inwardly toward the core 12 to reduce their cylinder volumes. However, there is no gas flow around this portion of the cycle, i.e., cylinders 32b and 32c and their pistons 38b and 38c. Accordingly, the intake charge drawn in during the first portion of the cycle is compressed in those cylinders 32b, 32c. As the intake and compression cylinder row 30 continues to rotate, its cylinders will align with the compression transfer passage 66 (FIG. 3) of the core 12, with the high-pressure charge in the cylinders flowing through the compression transfer passage 66 to the combustion chamber 64. Fuel is injected by the fuel injector 56 (FIGS. 2 and 3), and the fuel and air mixture is ignited by the igniter 58 (spark plug, etc., FIGS. 2 and 3) to produce heat and pressure for engine power.

FIG. 6 of the drawings illustrates the power and exhaust portions of the operating cycle of the engine 10. As in FIG. 5, the lower pistons in FIG. 6 are at or toward their innermost positions, i.e., with minimal cylinder volumes. However, it will be noted that as the view shown in FIG. 6 is from the opposite end of the engine 10 from that shown in FIGS. 4 and 5, the rotation of the rotary components of the engine, i.e., the power and exhaust cylinder row 34, its pistons 40a through 40f, the connecting rods 44a through 44f, and the outer casing 20 of the housing 18, are all rotating clockwise about the combustion section 48 of the stationary core 12 as viewed in FIG. 6, as indicated by the rotational arrow R2. During the power portion of the cycle, the cylinders rotate to align themselves with the combustion transfer channel 70 (FIG. 3) of the core 12, i.e., cylinders 36d, 36e, and 36f and their pistons 40d, 40e, and 40f. The high pressure gas delivered from the combustion chamber 64 through the combustion gas passage 68 to the combustion transfer channel 70 passes into the cylinders 36d, 36e, and 36f through the passages 92 of the power and exhaust seal band 84 and the passages 94 in the inner cylinder wall of the power and exhaust cylinder row 34.

When the power and exhaust cylinders have rotated to about the positions of cylinders 36f and 36a, their pistons 40f and 40a are at or near their most outward travel, i.e., their cylinder volumes are at or near their maximum. Thus, practically all of the power available from the expansion of the combustion charge in these cylinders has been spent. Accordingly, the beginning of the semicircumferential exhaust gas transfer passage 74 is encountered at about this point, i.e., at about the location of the cylinder 36a. (The precise locations of the beginning and end points of the exhaust gas transfer passage 74 may be adjusted as desired for optimum engine efficiency.) As the power and exhaust cylinder row 34 continues to rotate clockwise about the stationary combustion section 48 of the core 12, its pistons are forced inwardly in their respective cylinder bores to expel the exhaust gases therefrom. This would occur throughout the rotational arc subtended by cylinders 36a, 36b, and 36c, and their pistons 40a, 40b, and 40c in FIG. 6. The rotating cylinders reach the end of the exhaust gas transfer passage 74 just before reaching the beginning of the combustion transfer channel 70, i.e., at about the location of cylinders 36c to 36d in FIG. 5. At this point the pistons are at about their most inward travel, i.e., smallest cylinder volume, and have expelled substantially all of the spent combustion gases as exhaust. The power and exhaust cylinder row continues to rotate clockwise, aligning cylinder 36d with the beginning of the combustion transfer channel 70 to continue the operational cycle of the engine 10.

It has been noted further above that the stationary core 12 includes two sections about which the two cylinder rows rotate, i.e., the intake and compression section 46 about which the intake and compression cylinder row 30 rotates, and the combustion section 48 about which the power and exhaust cylinder row 34 rotates. These two cylinder rows 30 and 34 are affixed to one another and rotate in unison, but are axially displaced corresponding to the axial displacement of the intake and compression section 46 and combustion section 48 of the core 12. The engine 10 operates by means of a “split cycle” principle, i.e., each cylinder row is dedicated to one half of the functions of the engine operating cycle. All intake and compression operations occur in the intake and compression cylinder row 30, and all power and exhaust operations occur in the power and exhaust cylinder row 34. There are no power or exhaust operations in the intake and compression cylinders, and there are no intake and compression operations in the power and exhaust cylinders. As each cylinder row handles only two of the four functions in the engine operating cycle, it will be seen that at least two cylinder rows are required in the rotary piston engine 10. However, the basic configuration of the engine 10 may be expanded to include additional cylinder rows, if so desired. The basic configuration of the rotary piston engine 10 comprises an even number of rows, i.e., two, four, six, eight, etc., due to the “split cycle” requirement for two cylinder rows to carry out all of the functions of the engine operation. However, it will be seen that the intake and compression cylinder row(s) may have a different number of cylinders, different compression ratios, and/or different displacements than the power and exhaust cylinder rows. There is no requirement for correspondence of these factors between the intake and compression cylinder row(s) and the power and exhaust cylinder row(s), as each of the various rows is dedicated to only two of the four operational strokes of the conventional four-stroke cycle reciprocating internal combustion engine, to the exclusion of the other two strokes of the operation. Thus, certain embodiments of the present rotary piston engine may include one or more rows of intake and compression pistons supplying compressed intake charges to the central combustion chamber (or perhaps chambers, in the case of multiple cylinder rows) of the core and thence to a different number of rows of power and exhaust cylinders, with the intake and compression cylinder rows differing from the power and exhaust cylinder rows in the number of rows, the number of cylinders in each row, the compression ratios of the cylinders, and/or the displacements of the cylinders, as desired.

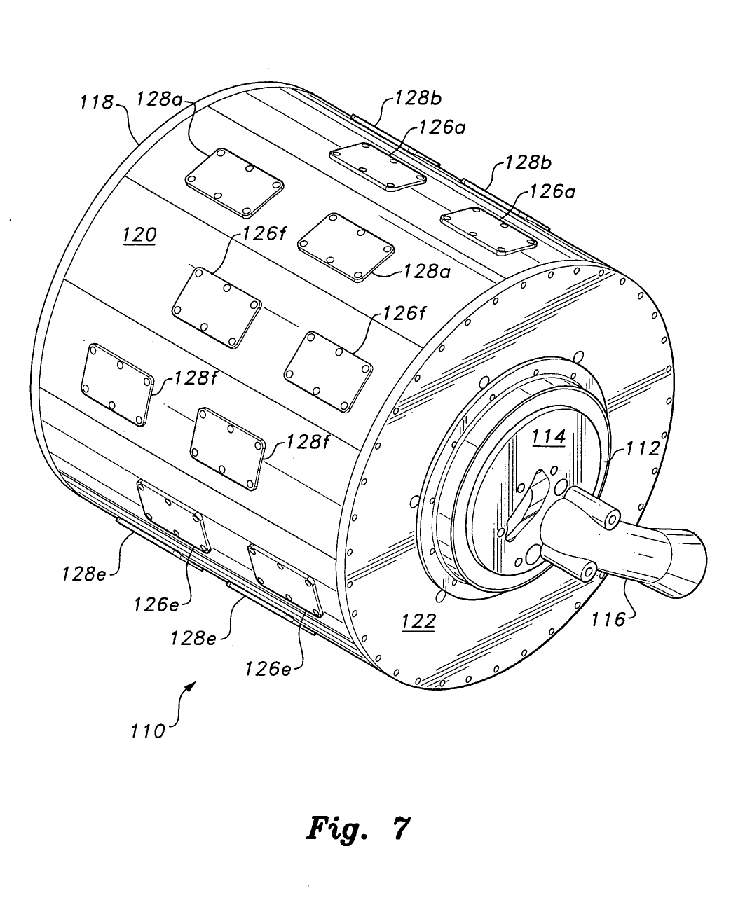

FIG. 7 provides a perspective view of such an alternative rotary piston engine 110, having four cylinder rows. The engine 110 is essentially an elongated embodiment of the engine 10 of FIGS. 1 through 6, described in detail above. The stationary central core 112 includes two inlet sections and two combustion sections, with these sections being staggered in an alternating array as evidenced by the locations of the connecting rod attachment plates about the outer casing 120. The generally cylindrical housing 118 and its casing 120 are somewhat longer than the corresponding components of the engine 10 illustrated in FIG. 1, due to the longer central core 112 and the four cylinder rows within the housing 118. However, the basic operation of the engine 110 remains the same as that described further above for the engine 10. The engine 110 includes a first row of intake and compression row connecting rod attachment plates 126a through 126f, closest to the inlet end plate 122 of the engine. Not all plates are shown due to the perspective view, but it will be understood that the configuration of this first row of connecting rod attachment plates 126a through 126f is distributed about the casing 120 of the engine 110 essentially as shown in FIGS. 4 and 5 for the engine 10. The next row of connecting rod attachment plates 128a through 128f is for the first of the two power and exhaust cylinder rows within the engine housing 118. This configuration repeats with a third row of connecting rod attachment plates, i.e., a second row of intake and compression row connecting rod attachment plates 126a through 126f, with a fourth row of plates, i.e., a second row of power and exhaust connecting rod attachment plates 128a through 128f following.

While the rotary piston engine 110 of FIG. 7 has four cylinder rows therein, it will be seen that other engine embodiments may be constructed having even more cylinder rows, as desired. Each set of intake and compression and power and exhaust cylinder rows will contain its own dedicated combustion chamber within the core, with appropriate gas transfer passages extending therefrom through the core. The advantages of a single fuel source and single ignition source serving the multiple cylinders of each power and exhaust cylinder row, will be appreciated for their relative simplicity in comparison with a conventional piston engine requiring a separate injector and ignition source for each cylinder. Moreover, the present rotary piston engine in its various embodiments promises to provide smoothness of operation that is unachieved in conventional engines having an equivalent number of cylinders, as the combustion process becomes a nearly continuous operation when several cylinders are provided in each cylinder row. As the present rotary piston engine accomplishes its gas transfer processes essentially by a means somewhat analogous to a rotary valve principle, conventional valves with their springs, cams, tappets, rocker arms, etc., are unnecessary in the present engine, thus providing additional economy of manufacture. Accordingly, the rotary piston engine in its various embodiments provides a number of significant advantages over conventional internal combustion engine technology.

It is to be understood that the present invention is not limited to the embodiment(s) described above, but encompasses any and all embodiments within the scope of the following claims.

1. A rotary piston engine, comprising:
a stationary central core having a central axis and mutually separate inlet and combustion sections;
a plurality of cylinder rows disposed about the core, each of the cylinder rows having a plurality of radially disposed cylinders, each of the cylinder rows rotating about the core during engine operation; and
a piston disposed for reciprocation within each of the cylinders, each of the pistons having a crown oriented toward the core and an outwardly oriented skirt opposite the crown.

2. The rotary piston engine according to claim 1, further including:
a closed outer housing surrounding the cylinder rows, the outer housing rotating coaxially about the central axis of the core during engine operation; and
a connecting rod extending generally radially outwardly from each of the pistons, each of the connecting rods connecting the corresponding piston to the outer housing.

3. The rotary piston engine according to claim 1, wherein:
one cylinder row is disposed about each of the inlet and combustion sections; and
a closed outer housing surrounds the cylinder rows, the housing rotating coaxially about the central axis of the core, the housing being linked to at least one cylinder row and rotating in unison therewith during engine operation.

4. The rotary piston engine according to claim 1, wherein:
the inlet and combustion sections are radially offset from the central axis of the core; and
one of the cylinder rows is disposed about each of the inlet and combustion sections.

5. The rotary piston engine according to claim 1, further including:
an inlet end extending from the inlet section of the core, the inlet end having an intake passage therethrough, the inlet section of the core having an inlet chamber therein, a periphery with a semicircumferential inlet transfer channel therein, and a compression transfer passage, the inlet transfer channel and the intake passage communicating with the inlet chamber; and
an outlet end extending from the combustion section of the core, the outlet end having an exhaust passage therethrough, the combustion section of the core having a periphery with a semicircumferential combustion transfer channel therein and an exhaust transfer passage, the exhaust transfer passage communicating with the exhaust passage of the outlet end;
the core further having a combustion chamber therein, the combustion chamber traversing the inlet section and the combustion section of the core, the combustion chamber communicating with the compression transfer passage of the inlet section and with the combustion transfer channel of the combustion section of the core.

6. The rotary piston engine according to claim 1, wherein:
the core includes at least one inlet section and at least one combustion section in an axially alternating array;
the plurality of cylinder rows are disposed alternately about an inlet section of the core and a combustion section of the core;
each cylinder row disposed about an inlet section of the core has cylinders limited to intake and compression functions; and
each cylinder row disposed about a combustion section of the core has cylinders limited to combustion and exhaust functions.

7. The rotary piston engine according to claim 1, wherein the cylinder rows are circumferentially offset from one another in an alternating array about the core.

8. A rotary piston engine, comprising:
a stationary central core having a central axis;
a plurality of cylinder rows disposed about the core, each of the cylinder rows having a plurality of radially disposed cylinders, each of the cylinder rows rotating about the core during engine operation;
a closed outer housing surrounding the cylinder rows, the housing rotating coaxially about the central axis of the core during engine operation;
a piston disposed for reciprocation within each of the cylinders; and
a connecting rod extending generally radially outwardly from each piston, each connecting rod connecting its respective piston to the housing.

9. The rotary piston engine according to claim 8, wherein each said piston has a crown oriented toward the core and an outwardly oriented skirt opposite the crown.

10. The rotary piston engine according to claim 8, wherein:
the core further includes mutually separate inlet and combustion sections;
one of the cylinder rows is disposed about each of the inlet and combustion sections; and
the housing is linked to at least one of the cylinder rows and rotates in unison therewith during engine operation.

11. The rotary piston engine according to claim 8, wherein:
the core includes at least one inlet section and at least one combustion section, the inlet and combustion sections being radially offset from the central axis of the core; and
one cylinder row is disposed about each of the inlet and combustion sections.

12. The rotary piston engine according to claim 8, wherein:
the core has an inlet section and a combustion section;
an inlet end extends from the inlet section of the core, the inlet end having an intake passage therethrough;
an outlet end extends from the combustion section of the core, the outlet end having an exhaust passage therethrough;
the inlet section of the core has an inlet chamber therein, a periphery with a semicircumferential inlet transfer channel therein, and a compression transfer passage, the inlet transfer channel and the intake passage communicating with the inlet chamber;
the combustion section of the core has a periphery with a semicircumferential combustion transfer channel therein and an exhaust transfer passage, the exhaust transfer passage communicating with the exhaust passage of the outlet end; and
the core has a combustion chamber therein, the combustion chamber traversing the inlet section and the combustion section of the core, the combustion chamber communicating with the compression transfer passage of the inlet section and with the combustion transfer channel of the combustion section of the core.

13. The rotary piston engine according to claim 8, wherein:
the core includes at least one inlet section and at least one combustion section in an axially alternating array;
the cylinder rows are disposed alternately about an inlet section of the core and a combustion section of the core;
each cylinder row disposed about an inlet section of the core has cylinders limited to intake and compression functions; and
each cylinder row disposed about a combustion section of the core has cylinders limited to combustion and exhaust functions.

14. The rotary piston engine according to claim 8, wherein the cylinder rows are circumferentially offset from one another in an alternating array about the core.

15. A rotary piston engine, comprising:
a stationary central core having a central axis and mutually separate inlet and combustion sections;
a cylinder row disposed about each of the inlet and combustion sections, each of the cylinder rows having a plurality of radially disposed cylinders, each of the cylinder rows rotating about a respective one of the inlet and combustion sections of the core;
a piston disposed for reciprocation within each of the cylinders; and
a closed outer housing rotating coaxially about the central axis of the core, the housing being linked to at least one of the cylinder rows and rotating in unison therewith during engine operation.

16. The rotary piston engine according to claim 15, wherein each said piston has a crown oriented toward the core and an outwardly oriented skirt opposite the crown.

17. The rotary piston engine according to claim 15, further including a connecting rod extending generally radially outwardly from each of the pistons, each of the connecting rods connecting the corresponding piston to the housing.

18. The rotary piston engine according to claim 15, wherein:
the inlet and combustion sections are radially offset from the central axis of the core; and
one cylinder row is disposed about each of the inlet and combustion sections.

19. The rotary piston engine according to claim 15, further including:
an inlet end extending from the inlet section of the core, the inlet end having an intake passage therethrough, the inlet section of the core further having an inlet chamber therein, a periphery with a semicircumferential inlet transfer channel therein, and a compression transfer passage, the inlet transfer channel and the intake passage communicating with the inlet chamber; and
an outlet end extending from the combustion section of the core, the outlet end having an exhaust passage therethrough, the combustion section of the core further having a periphery with a semicircumferential combustion transfer channel therein and an exhaust transfer passage, the exhaust transfer passage communicating with the exhaust passage of the outlet end;
the core further having a combustion chamber therein, the combustion chamber traversing the inlet section and the combustion section of the core, the combustion chamber communicating with the compression transfer passage of the inlet section and with the combustion transfer channel of the combustion section of the core.

20. The rotary piston engine according to claim 15, wherein:
the core includes at least one inlet section and at least one combustion section in an axially alternating array;
the cylinder rows are disposed alternately about an inlet section of the core and a combustion section of the core;
each of the cylinder rows disposed about an inlet section of the core has cylinders limited to intake and compression functions;
each of the cylinder rows disposed about a combustion section of the core has cylinders limited to combustion and exhaust functions; and
the cylinder rows are circumferentially offset from one another in an alternating array about the core.
